(19) United States
(12) Patent Application Publication
(10) Pub. No.: US 2025/0239840 A1
(43) Pub. Date: Jul. 24, 2025

(54) HARNESS ASSEMBLY

(71) Applicants: TOYOTA JIDOSHA KABUSHIKI KAISHA, Toyota-shi (JP); GKN Automotive Limited, Birmingham (GB)

(72) Inventors: Naotaka KAKISAKA, Toyota-shi (JP); Hideyuki INOSE, Tochigi-shi (JP); Shouji YOSHIDA, Tochigi-shi (JP)

(73) Assignees: TOYOTA JIDOSHA KABUSHIKI KAISHA, Toyota-shi (JP); GKN Automotive Limited, Birmingham (GB)

(21) Appl. No.: 19/027,143

(22) Filed: Jan. 17, 2025

(30) Foreign Application Priority Data
Jan. 23, 2024 (JP) 2024-008329

(51) Int. Cl. H02G 3/04; B60R 16/02; F16H 48/34; F16H 57/02; F16H 57/037; H01B 7/00

(52) U.S. Cl. CPC H02G 3/0481; F16H 48/34; F16H 57/037; H01B 7/0045; B60R 16/0207; F16H 2057/02026; F16H 2057/02052

(57) ABSTRACT

A harness assembly for connecting between an actuator disposed in a housing that houses a rotary member, and a connector that is fixed to the housing. The harness assembly includes a wire harness and a protection tube covering the wire harness. The wire harness is to be connected at its end portion to the actuator, and at its another end portion to the connector. The harness assembly is sectioned into a high-rigidity portion and a low-rigidity portion. The wire harness is covered with the protection tube in the high-rigidity portion, and such that the wire harness is at least partially uncovered with the protection tube in the low-rigidity portion. The low-rigidity portion is provided in a position that avoids the harness assembly from being brought into contact with the rotary member, by being bent at the low-rigidity portion when the other end portion is connected to the connector.

This application claims priority from Japanese Patent Application No. 2024-008329 filed on Jan. 23, 2024, the disclosure of which is herein incorporated by reference in its entirety.

### FIELD OF THE INVENTION

The present invention relates to a harness assembly including a wire harness and a protection tube.

### BACKGROUND OF THE INVENTION

There is well known a harness assembly including (a) a wire harness that includes a plurality of wires bundled together and (b) a protection tube that covers an outer circumference of the wire harness. For example, JP 2017-13703 A discloses such a wire harness. The wire harness disclosed in this Japanese Patent Application Publication includes a bent portion that is surrounded by a rubber tube.

### SUMMARY OF THE INVENTION

By the way, there is case in which the harness assembly is provided between an actuator disposed in a housing as a non-rotary member that houses a rotary member, and a connector that is fixed to the housing, wherein the wire harness is connected at an end portion thereof with the actuator, and at another end portion thereof with the connector. In this case, considering workability of connecting the wire harness to the connector of the housing, the harness assembly needs to have a length large enough. However, depending on rigidity of the harness assembly, it may be difficult to control trajectory of the harness assembly when connecting the wire harness to the connector of the housing. This requires careful work to avoid contact between the harness assembly and the rotary member when connecting the wire harness to the connector of the housing. Controlling the trajectory of the harness assembly is synonymous with wiring of the harness assembly.

The present invention was made in view of the background art described above. It is therefore an object of the present invention to provide a harness assembly that makes it possible to easily control trajectory of the harness assembly such that contact with the rotary member is avoided when connecting the wire harness to the connector of the housing.

The object indicated above is achieved by the present invention.

The present invention provides a harness assembly that is to be provided between an actuator disposed in a housing as a non-rotary member that houses a rotary member, and a connector that is fixed to the housing. The harness assembly includes: a wire harness which includes a plurality of wires bundled together, and which is to be connected at an end portion thereof to the actuator, and at another end portion thereof to the connector; and a protection tube which covers an outer circumference of the wire harness. The harness assembly is sectioned into a high-rigidity portion and a low-rigidity portion that is more flexible than the high-rigidity portion, such that the wire harness is covered with the protection tube in the high-rigidity portion, and such that the wire harness is at least partially uncovered with the protection tube in the low-rigidity portion. The low-rigidity portion is provided in a position that avoids the harness assembly from being brought into contact with the rotary member, by being bent at the low-rigidity portion when the other end portion is connected to the connector.

In the harness assembly electric work vehicle according to the present invention, the harness assembly including the wire harness and the protection tube is sectioned into the high-rigidity portion and the low-rigidity portion that is more flexible than the high-rigidity portion, such that the wire harness is covered with the protection tube in the high-rigidity portion, and such that the wire harness is at least partially uncovered with the protection tube in the low-rigidity portion. The low-rigidity portion is provided in the position that avoids the harness assembly from being brought into contact with the rotary member, by being bent at the low-rigidity portion when the other end portion of the wire harness is connected to the connector fixed to the housing. Thus, the harness assembly can be easily bent at the position that avoids the harness assembly from being brought into contact with the rotary member. Therefore, it is possible to control trajectory of the harness assembly in a manner that avoids contact of the harness assembly with the rotary member in an operation for connecting the wire harness to the connector of the housing.

### BRIEF DESCRIPTION OF THE DRAWINGS

FIG. 1 is a view schematically showing, by way of example, a differential gear device that is to be installed in a vehicle;

FIG. 2 is a view schematically showing, by way of example, a harness assembly to which the present invention is applied;

FIG. 3 is a view showing, by way of example, a state in which the harness assembly is provided in the housing;

FIG. 4 is a view showing inside of the housing, as seen from a right side of the housing in FIG. 1;

FIG. 5 is a view showing, by way of example, a state in which the harness assembly is provided in the housing, wherein this example is other than the example shown in FIG. 3; and

FIG. 6 is a view showing inside of the housing, as seen from a right side of the housing in FIG. 1, wherein this example is other than the example shown in FIG. 4.

### DETAILED DESCRIPTION OF PREFERRED EMBODIMENTS

Hereinafter, embodiments of the invention will be described in detail with reference to the accompanying drawings.

### First Embodiment

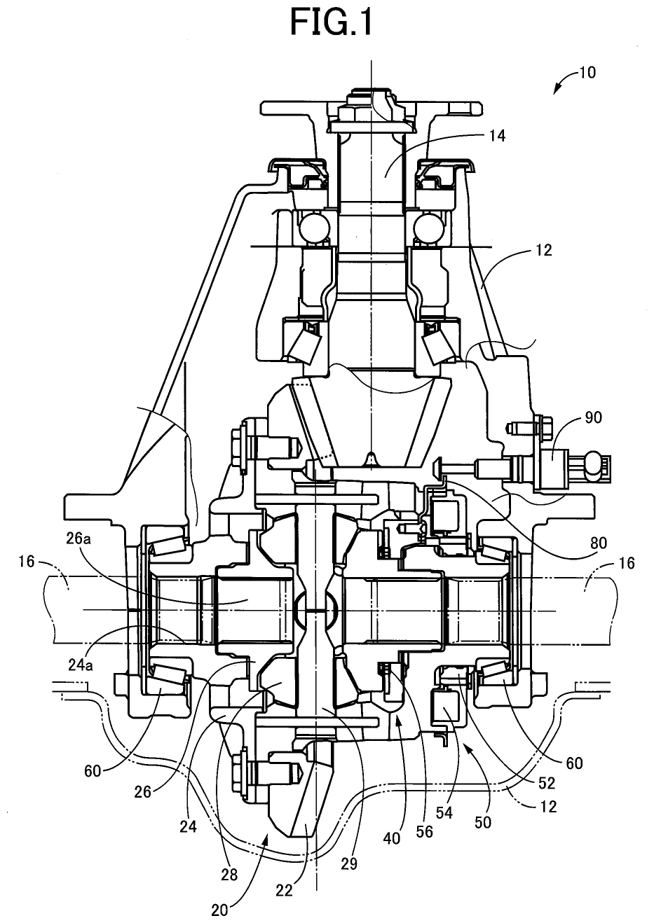

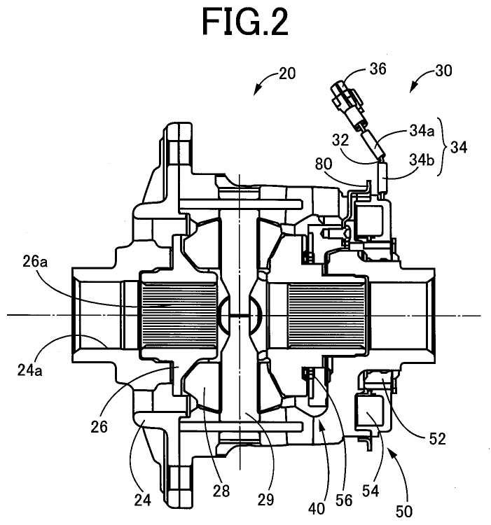

FIG. 1 is a view schematically showing, by way of example, a differential gear device 20 that is to be installed in a vehicle 10. FIG. 2 is a view schematically showing, by way of example, a harness assembly 30 to which the present invention is applied.

As shown in FIG. 1 and FIG. 2, the vehicle 10 includes a housing 12, a propeller shaft 14, a pair of drive shafts 16, a differential gear device 20, a clutch 40, an actuator 50 and a plurality of bearings 60, in addition to the above-described harness assembly 30.

The housing 12 is a non-rotary member fixed to a body of the vehicle 10. The differential gear device 20 is connected to the propeller shaft 14. The drive shafts 16 are connected to the differential gear device 20. In the vehicle 10, a power from a power source (not shown) is transmitted to left and right drive wheels (not shown) via the propeller shaft 14, the differential gear device 20 and the right and left drive shafts 16, for example.

The differential gear device 20 is housed in the housing 12. The differential gear device 20 includes a differential ring gear 22, a differential casing 24, a pair of differential side gears 26, a pair of differential pinions 28 and a pair of pinion shafts 29.

The differential ring gear 22 is integrally connected to outside of the differential casing 24, and meshes with the propeller shaft 14. The differential casing 24 is rotatably supported by the housing 12 through the bearings 60. The differential side gears 26, the differential pinions 28 and the pinion shafts 29 are housed in the differential casing 24. The differential casing 24 is formed with bore portions 24a as through-holes into which the drive shafts 16 are fitted so as to be rotatable relative to the differential casing 24. Each of the differential side gears 26 has spline teeth formed in an inner circumferential surface 26a of its through-hole in which a corresponding one of the drive shafts 16 is fitted so as not to be rotatable relative to each of the differential side gears 26. The differential gear device 20, which is thus constructed, is a known differential mechanism configured to distribute the power of the power source transmitted from the propeller shaft 14 to the left and right drive wheels.

The clutch 40 is housed in the housing 12, and is provided in the differential gear device 20. The clutch 40 is a dog clutch (i.e., a meshing clutch) configured to selectively connect and disconnect the differential casing 24 to and from one of the differential side gears 26 that is on side of the clutch 40. The clutch 40 is to be moved by the actuator 50 between an engaged position and a non-engaged position, namely, switched by the actuator 50 between an engaged state and a released state.

The actuator 50 is disposed in the housing 12, and includes a plunger 52, a solenoid 54 and a return spring 56. The solenoid 54 generates a predetermined magnitude of thrust on the plunger 52, when a drive current is supplied through the harness assembly 30 in a response to a command from an electronic control device (not shown). The actuator 50 is a device that is configured to move the clutch 40 to the engaged position by the above-described thrust force. The return spring 56 is a spring that constantly forces the clutch 40 to be returned to the non-engaged position.

In the released state of the clutch 40, the power inputted to the differential casing 24 is transmitted to the right and left differential side gears 26 through the pinion shafts 29 and differential pinions 28 in sequence. When the clutch 40 is in the released state, the differential gear device 20 is placed in a differential state that allows the right and left differential side gears 26 to be rotated at respective speeds that are different 20) from each other. On the other hand, when the clutch 40 is in the engaged state, the differential casing 24 is integrally connected to one of the differential side gears 26 that is on side of the clutch 40, so that the power inputted to the differential casing 24 is also directly transmitted to the one of the differential side gears 26 that is on side of the clutch 40. When the clutch 40 is in the engaged state, the differential gear device 20 is placed in a differential lock state in which the differential casing 24 and the right and left differential side gears 26 are integrally rotated whereby the differential state is limited.

The harness assembly 30 is located in the housing 12, and includes a wire harness 32, a protection tube 34 and a connector 36.

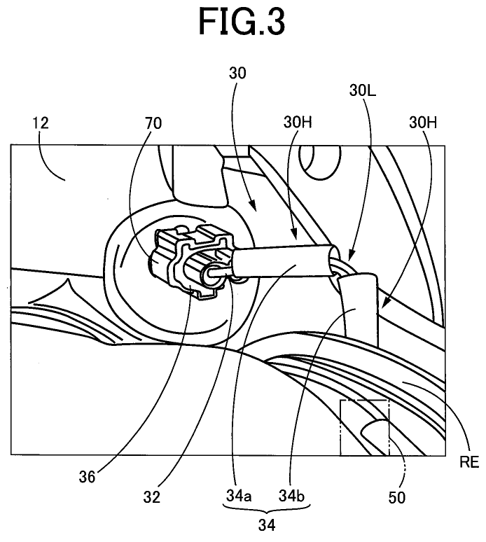

FIG. 3 is a view showing, by way of example, a state in which the harness assembly 30 is provided in the housing 12. As shown in FIG. 3, the vehicle 10 includes a mating connector 70 fixed to the housing 12. The mating connector 70 is a connector into which the connector 36 is to be fitted. The wire harness 32 includes a plurality of wires bundled together, and is to be connected at an end portion thereof to the actuator 50, particularly, the solenoid 54 (see FIG. 2). The wire harness 32 is connected at another end portion thereof with the connector 36. In the state in which the harness assembly 30 is provided in the housing 12, the connector 36 is fitted in the mating connector 70, so that the wire harness 32 is connected at the other end portion thereof to the mating connector 70 through the connector 36. The protection tube 34 is a tube provided to cover an outer circumference of the wire harness 32. It is noted that the mating connector 70 cooperates with the harness assembly 30 and the actuator 50 to constitute an actuator system.

Each of the harness assembly 30 and the solenoid 54 is a non-rotary element or member that is fixed to the housing 12. On the other hand, each of the differential gear device 20, the clutch 40 and a rotary plate 80 (see FIG. 1 and FIG. 2) is a rotary element or member that is housed in the housing 12. The rotary plate 80 is a part that cooperates with a position detection sensor 90 (see FIG. 1) to detect whether the clutch 40 provided in the vehicle 10 is in the engaged position or not. The position detection sensor 90 is fixed in the housing 12.

It is desirable that the harness assembly 30 be prevented from coming into contact with the differential gear device 20, particularly, the differential casing 24 and the rotary plate 80, when assembled in the housing 12. Meanwhile, considering workability of connecting the connector 36 to the mating connector 70, the wire harness 32 needs to have a length large enough. However, the more flexible and longer the wire harness 32 is, the more difficult it becomes to control trajectory of the harness assembly 30. As a result, when mating the connector 36 with the mating connector 70, careful work is required to avoid contact between the harness assembly 30 and the differential casing 24 or the rotary plate 80. The differential casing 24 and the rotary plate 80 are rotary members RE that may come into contact with the harness assembly 30.

The protection tube 34 is harder to be bent where the protection tube 34 is short than where the protection tube 34 is long. In other words, the shorter the protection tube 34, the higher its rigidity. In view of this, the wire harness 32 is sectioned into a portion that is covered with the protection tube 34 and a portion that is not covered with the protection tube 34, so that the harness assembly 30 as a whole is sectioned into a high-rigidity portion 30H and a low-rigidity portion 30L that is more flexible than the high-rigidity portion 30H (see FIG. 3). That is, the high-rigidity portion 30H, in which the wire harness 32 is covered with the protection tube 34, is hard to be bent, while the low-rigidity portion 30L, in which the wire harness 32 is uncovered with the protection tube 34, is easy to be bent.

When mating the connector 36 with the mating connector 70, the harness assembly 30 is easily bent at the low-rigidity portion 30L. In this instance, the harness assembly 30 is bent in a manner avoiding contact between the harness assembly 30 and the rotary member RE. The low-rigidity portion 30L is provided in a position that avoids the harness assembly 30 from being brought into contact with the rotary member RE, by being bent at the low-rigidity portion 30L when the other end portion of the wire harness 32 is connected to the mating connector 70.

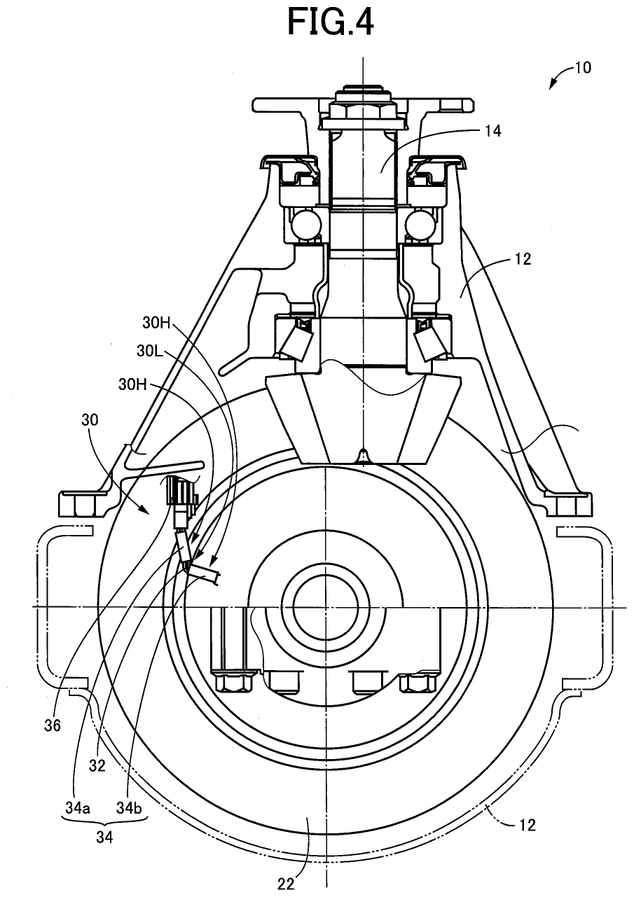

FIG. 4 is a view showing inside of the housing 12, as seen from a right side of the housing 12 in FIG. 1, namely, as seen from side of the position detection sensor 90. As shown in FIG. 3 and FIG. 4, the protection tube 34 is divided into a first tube 34a and a second tube 34b. In the harness assembly 30, the high-rigidity portion 30H includes a first part and a second part, such that the wire harness 32 is covered with the first tube 34a in the first part of the high-rigidity portion 30H, and such that the wire harness 32 is covered with the second tube 34b in the second part of the high-rigidity portion 30H. Further, in the harness assembly 30, the low-rigidity portion 30L, in which the wire harness 32 is not covered with the protection tube 34, is located between the first part and the second part of the high-rigidity portion 30H. The wire harness 32 is uncovered with the protection tube 34 in the low-rigidity portion 30L, with the protection tube 34 being divided into the first tube 34a and the second tube 34b, by being cut at its entire periphery in the low-rigidity portion 30L.

When the harness assembly 30 is bent at the low-rigidity portion 30L, the first tube 34a and the second tube 34b are easily moved to an opposite side of the low-rigidity portion 30L. For example, the second tube 34b is easily moved toward the solenoid 54. This makes it difficult to cause the wire harness 32 to be bent at its portion between the second tube 34b and the solenoid 54 (see FIG. 2), thereby making it easier to take the wire harness 32 straight out of a housing of the solenoid 54. The second tube 34b has a length that causes the second tube 34b to be pressed against the solenoid 54 when the harness assembly 30 is bent at the low-rigidity portion 30L. The protection tube 34 is preformed such that the second tube 34b has a length that allows its actuator-side end (that is on side of the actuator 50) to be brought close to the actuator 50 when the harness assembly 30 is bent at the low-rigidity portion 30L.

If the harness assembly 30 is made to have a length that is equal to a shortest distance from the solenoid 54 to the mating connector 70, a workability for fitting the connector 36 to the mating connector 70 could be reduced. On the other hand, if the harness assembly 30 is made to have a sufficient length, the harness assembly 30 could be more likely to come into contact with the rotary member RE. Therefore, the harness assembly 30 is made to have the sufficient length which is larger than in a case in which the harness assembly 30 connects between the actuator 50 and the mating connector 70 in the shortest distance, and which avoids contact of the harness assembly 30 with the rotary member RE.

From another point of view, if the harness assembly 30 is made to have the length that is equal to the shortest distance from the solenoid 54 to the mating connector 70, the harness assembly 30 could be likely to come into contact with the rotary member RE. However, for avoiding contact of the harness assembly 30 with the rotary member RE, if the harness assembly 30 is made longer too much, it becomes difficult to control the trajectory of the harness assembly 30. Therefore, the harness assembly 30 has a length that is larger than a case in which the harness assembly 30 connects between the actuator 50 and the mating connector 70 in the shortest distance, and the harness assembly 30 is bent at the low-rigidity portion 30L into a shape that avoids contact of the harness assembly 30 with the rotary member RE.

The low-rigidity portion 30L may be formed also even without the protection tube 34 being cut at its entire periphery. That is, the protection tube 34 does not necessarily have to be divided into the first tube 34a and the second tube 34b by being cut at its entire periphery in the low-rigidity portion 30L. For example, the low-rigidity portion 30L may be formed also with the protection tube 34 being cut only at a part of its periphery.

### Second Embodiment

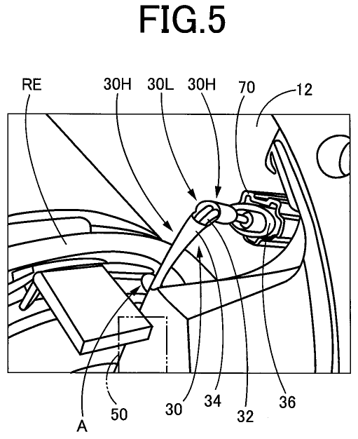

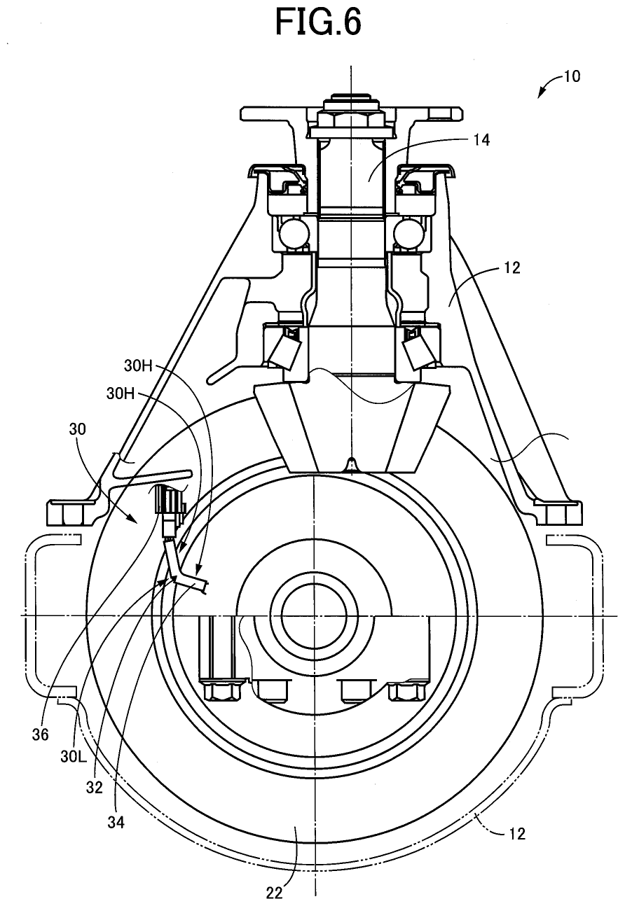

FIG. 5 and FIG. 6 show a second embodiment as another embodiment of the present invention. FIG. 5 is a view showing, by way of example, a state in which the harness assembly 30 is provided in the housing 12, wherein this example is other than the example shown in FIG. 3. FIG. 6 is a view showing inside of the housing 12, as seen from a right side of the housing 12 in FIG. 1, namely, as seen from side of the position detection sensor 90, wherein this example is other than the example shown in FIG. 4. As shown in FIG. 5 and FIG. 6, a slit is provided in a part of the periphery of the protection tube 34, such that the slit extends in a circumferential direction of the protection tube 34 over a distance corresponding to that part of the periphery. The harness assembly 30 is made easier to be bent at the above-described part of the periphery of the protection tube 34 in which the slit is provided, and a direction of bending of the harness assembly 30 is dependent on a position of the slit, so as to be controllable. In the high-rigidity portion 30H, the wire harness 32 is covered with the protection tube 34. In the low-rigidity portion 30L, the protection tube 34 being cut only at the part of its periphery whereby the wire harness 32 is partially uncovered with the protection tube 34. The wire harness 32 is partially uncovered with the protection tube 34 in the low-rigidity portion 30L, with the protection tube 34 being cut at the part of its periphery in the low-rigidity portion 30L, such that the cut part of the periphery of the protection tube 34 faces away from the direction in which the harness assembly 30 is bent at the low-rigidity portion 30L. In FIG. 5, reference sign “A” indicates an exit through which the wire harness 32 is to be extracted from the solenoid 54.

As described above, in the above-described embodiments, the harness assembly 30 includes the high-rigidity portion 30H and the low-rigidity portion 30L that is more flexible than the high-rigidity portion 30H, such that the wire harness 32 is covered with the protection tube 34 in the high-rigidity portion 30H, and such that the wire harness 32 is uncovered with the protection tube 34 in the low-rigidity portion 30L. The low-rigidity portion 30L is provided in the position that avoids the harness 10) assembly 30 from being brought into contact with the rotary member RE, by being bent at the low-rigidity portion 30L when the other end portion of the wire harness 32 is connected to the mating 70. Thus, the harness assembly 30 can be easily bent at the position that avoids the harness assembly 30 from being brought into contact with the rotary member RE. Therefore, it is possible to control trajectory of the harness assembly 30 in a manner that avoids contact of the harness assembly 30 with the rotary member RE in an operation for connecting the wire harness 32 to the mating connector 70.

In the above-described embodiments, the wire harness 32 is uncovered with the protection tube 34 in the low-rigidity portion 30L, with the protection tube 34 being cut at the entire periphery thereof in the low-rigidity portion 30L. Alternatively, the wire harness 32 is partially uncovered with the protection tube 34 in the low-rigidity portion 30L, with the protection tube 34 being cut at a part of the periphery thereof in the low-rigidity portion 30L, wherein the cut part of the periphery of the protection tube 34 faces away from a direction in which the harness assembly 30 is bent at the low-rigidity portion 30L. Thus, with the protection tube 34 being cut at the entirety or part of the periphery thereof in the low-rigidity portion 30L, the low-rigidity portion 30L is appropriately formed.

In the above-described embodiments, the protection tube 34 has a length that causes the actuator-side end of the protection tube 34 to be brought close to the actuator 50 when the harness assembly 30 is bent at the low-rigidity portion 30L. Thus, when the harness assembly 30 is bent at the low-rigidity portion 30L, a portion of the wire harness 32, which is located between the protection tube 34 and the actuator 50, is hard to be bent, thereby making it easy to remove the wire harness 32 straight from the actuator 50.

In the above-described embodiments, where the rotary member RE is located on a shortest distance line between the actuator 50 and the mating connector 70, namely, where the harness assembly 30 could be brought into contact with the rotary member RE if the harness assembly 30 connects between the actuator 50 and the mating connector 70 in a shortest distance, the harness assembly 30 has a length that allows the harness assembly 30 to connect between the actuator 50 and the connector 70 without contact of the harness assembly 30 with the rotary member RE. Thus, it is possible to easily control trajectory of the harness assembly 30 in a manner that avoids contact of the harness assembly 30 with the rotary member RE in an operation for connecting the wire harness 32 to the mating connector 70.

In the above-described embodiments, the harness assembly 30 has a length which is larger than in a case in which the harness assembly 30 connects between the actuator 50 and the connector 70 in a shortest distance, and the harness assembly 30 is bent at the low-rigidity portion 30L into a shape that avoids contact of the harness assembly 30 with the rotary member RE. Thus, it is possible to easily control trajectory of the harness assembly 30 in a manner that avoids contact of the harness assembly 30 with the rotary member RE in an operation for connecting the wire harness 32 to the mating connector 70.

While the preferred embodiments of this invention have described in detail by reference to the drawings, it is to be understood that the invention may be otherwise embodied.

For example, in the above-described embodiments, the present invention is applied to the harness assembly 30 through which a drive electric current or power is to be supplied to the actuator 50 configured to switch the differential gear device 20 of the vehicle 10 between the differential state and the differential lock state. In other words, in the above-described embodiments, the present invention is applied to the differential gear device 20 which is to be switched between the differential state and the differential lock state, and which includes the housing 12, the actuator 50, the rotary member RE, the harness assembly 30 and the mating connector 70, wherein the actuator 50 is to be driven with an electric power supplied through the harness assembly 30 that connects between the actuator 50 and the mating connector 70, so as to switch the differential gear device 20 between the differential state and the differential lock state. However, the present invention may be applied to any harness assembly that is to be provided between an actuator disposed in a housing, and a connector that is fixed to the housing, wherein the harness assembly includes: a wire harness which includes a plurality of wires bundled together, and which is to be connected at an end portion thereof to the actuator, and at another end portion thereof to the connector; and a protection tube which covers the wire harness. Further, the present invention may be applied also to a harness assembly that is to be used for a purpose other than a vehicle.

It is to be understood that the embodiments described above are given for illustrative purpose only, and that the present invention may be embodied with various modifications and improvements which may occur to those skilled in the art.

### NOMENCLATURE OF ELEMENTS

12: housing (non-rotary member)
20: differential gear device
24: differential casing (rotary member)
30: harness assembly
30H: high-rigidity portion
30L: low-rigidity portion
32: wire harness
34: protection tube
50: actuator
70: mating connector (connector)
80: rotary plate (rotary member)
RE: rotary member

What is claimed is:

1. A harness assembly that is to be provided between an actuator disposed in a housing as a non-rotary member that houses a rotary member, and a connector that is fixed to the housing,
the harness assembly comprising:
a wire harness which includes a plurality of wires bundled together, and which is to be connected at an end portion thereof to the actuator, and at another end portion thereof to the connector; and
a protection tube which covers an outer circumference of the wire harness,
wherein the harness assembly is sectioned into a high-rigidity portion and a low-rigidity portion that is more flexible than the high-rigidity portion, such that the wire harness is covered with the protection tube in the high-rigidity portion, and such that the wire harness is at least partially uncovered with the protection tube in the low-rigidity portion, and
wherein the low-rigidity portion is provided in a position that avoids the harness assembly from being brought into contact with the rotary member, by being bent at the low-rigidity portion when the other end portion is connected to the connector.

2. The harness assembly according to claim 1,
wherein the wire harness is at least partially uncovered with the protection tube in the low-rigidity portion, with the protection tube being cut at at least a part of a periphery thereof in the low-rigidity portion.

3. The harness assembly according to claim 1,
wherein the protection tube has a length that causes an actuator-side end of the protection tube to be brought close to the actuator when the harness assembly is bent at the low-rigidity portion.

4. The harness assembly according to claim 1,
wherein the rotary member is located on a shortest distance line between the actuator and the connector,
wherein the harness assembly has a length that allows the harness assembly to connect between the actuator and the connector without contact of the harness assembly with the rotary member.

5. The harness assembly according to claim 1,
wherein the harness assembly has a length which is larger than in a case in which the harness assembly connects between the actuator and the connector in a shortest distance, and
wherein the harness assembly is bent at the low-rigidity portion into a shape that avoids contact of the harness assembly with the rotary member.

6. The harness assembly according to claim 2,
wherein the wire harness is uncovered with the protection tube in the low-rigidity portion, with the protection tube being cut at the entire periphery thereof in the low-rigidity portion.

7. The harness assembly according to claim 2,
wherein the wire harness is partially uncovered with the protection tube in the low-rigidity portion, with the protection tube being cut at the part of the periphery thereof in the low-rigidity portion, and
wherein the part of the periphery of the protection tube faces away from a direction in which the harness assembly is bent at the low-rigidity portion.

8. A differential gear device that is to be switched between a differential state and a differential lock state,
the differential gear device comprising the housing, the actuator, the rotary member, the harness assembly and the connector that are recited in claim 1,
wherein the actuator is to be driven with an electric power supplied through the harness assembly that connects between the actuator and the connector, so as to switch the differential gear device between the differential state and the differential lock state.
